(19) United States
(12) Patent Application Publication
(10) Pub. No.: US 2024/0097423 A1
(43) Pub. Date: Mar. 21, 2024

(54) ADJUSTMENT MECHANISM FOR WEARABLE DEVICES

(71) Applicant: Apple Inc., Cupertino, CA (US)

(72) Inventors: Liam R. Martinez, San Francisco, CA (US); Javier Mendez, San Jose, CA (US); Samuel G. Smith, San Francisco, CA (US); Scott W. Slabaugh, Gilroy, CA (US)

(21) Appl. No.: 18/450,398

(22) Filed: Aug. 15, 2023

Related U.S. Application Data
(60) Provisional application No. 63/376,327, filed on Sep. 20, 2022.

(51) Int. Cl. H02G 11/00; A42B 7/00; G06F 1/16

(52) U.S. Cl. CPC H02G 11/003; A42B 7/00; G06F 1/163

(57) ABSTRACT

A wearable electronic device includes a first portion, a securement strap, and an electrical cable. The securement strap includes a track having a first terminus and a second terminus, a pulley translatably secured to the track, and an elastic member having a first end secured to the securement strap and a second end secured to the pulley. The electrical cable has a first end connected to the first portion and a second end connected to the securement strap, the electrical cable routed at least partially around the pulley.

### CROSS-REFERENCE TO RELATED APPLICATION(S)

This claims priority to U.S. Provisional Patent Application No. 63/376,327, filed 20 Sep. 2022, and entitled “Adjustment Mechanism for Wearable Devices,” the disclosure of which is hereby incorporated by reference.

### FIELD

The described embodiments relate generally to an adjustment mechanism of a head-mountable device. More particularly, the present embodiments relate to an adjustment mechanism with a constant force elastomeric spring of a head-mountable device.

### BACKGROUND

Recent advances in portable computing have enabled head-mountable devices that provide augmented and virtual reality (AR/VR) experiences to users. These head-mountable devices require many components for a user to properly don the head-mountable device, such as a facial engagement feature, padding, bands, securement mechanisms and other components. Certain components of the head-mountable device engage with portions of a user's head, securing the head-mountable device to the user's head to create and maintain a comfortable and enjoyable user experience. Securement components of conventional head-mountable devices are implemented in rudimentary ways, limiting the user's experience and leading to user discomfort and/or dissatisfaction, especially when used for long periods of time. Indeed, engagement devices intended to secure a user's head can be bulky, heavy, and/or cumbersome. In addition, because adjustable securement straps can change length as they are stretched and adjusted during use, securement straps typically do not include certain functional sub-components like electronic components and wiring.

Therefore, what is needed in the art are head-mountable engagement devices that apply are comfortable and immersive user experience while accommodating functional components during adjustment.

### SUMMARY

In at least one example of the present disclosure, a wearable electronic device includes a first portion, a securement strap, and an electrical cable. The securement strap includes a track having a first terminus and a second terminus, a pulley translatably secured to the track, and a spring having a first end secured to the securement strap and a second end secured to the pulley. The electrical cable has a first end connected to the first portion and a second end connected to the securement strap, the electrical cable routed at least partially around the pulley.

In one example, the spring biases the pulley toward the first terminus. In one example, when a force pulls the securement strap away from the first portion, the electrical cable biases the pulley toward the second terminus. In one example, the pulley rotates about an axle, the securement strap further includes a protrusion extending parallel to the axle, and the electrical cable is routed around the protrusion. In one example, the cable is routed around the pulley and the protrusion in a serpentine manner. In one example, the electrical cable is fixed in length. In one example, the first portion includes a display. In one example, the spring keeps the electrical cable in tension as the first portion is pulled away from the securement strap.

In at least one example of the present disclosure, a head-mountable display includes a display portion, a securement strap, and an adjustment mechanism connecting the securement strap to the display portion. The adjustment mechanism includes a pulley, a biasing member urging the pulley in a first direction, and an electrical cable routed at least partially around the pulley to bias the pulley in a second direction.

In one example, the electrical cable extends from the display portion to the securement strap. In one example, the securement strap includes the adjustment mechanism. In one example, the display portion includes the adjustment mechanism. In one example, the pulley includes a wheel rotatable around an axle and the biasing member includes an elastic band configured to urge the axle in the first direction. In one example, the adjustment mechanism further includes a track configured to guide the axle in the first direction and the second direction. In one example, the track defines a translation path and the pulley is coupled to the track such that the pulley is configured to move along the translation path.

In at least one example of the present disclosure, an adjustability mechanism connecting a first portion and a second portion of an electronic device includes a track defining a translation path, a pulley coupled to the track, an elastic band configured to bias the pulley in a first direction along the translation path, and a fixed length electrical cable extending from the first portion to the second portion and configured to bias the pulley in a second direction along the translation path.

In one example, the translation path is curved. In one example, the electronic device includes a head-mountable display. In one example, the first portion includes a display and the second portion includes a securement strap. In one example, the elastic band includes a first end connected to the pulley and a second end connected to the securement strap.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view of an example head-mountable device including a securement strap;

FIG. 2A shows a side view of a head-mountable device including a securement strap;

FIG. 2B shows a side view of a head-mountable device including a securement strap;

FIG. 3A shows an adjustment mechanism in a first position;

FIG. 3B shows an adjustment mechanism in a second position;

FIG. 4A shows an adjustment mechanism in a first position;

FIG. 4B shows an adjustment mechanism in a second position; and

FIG. 5 shows an adjustment mechanism.

### DETAILED DESCRIPTION

Reference will now be made to representative embodiments illustrated in the accompanying drawings. However, the following descriptions are not intended to limit the embodiments to one preferred embodiment. Rather, they are intended to cover alternatives, modifications, and equivalents as can be included within the spirit and scope of the described embodiments as defined by the appended claims.

The following disclosure relates to an adjustment mechanism of a head-mountable device. More particularly, the present embodiments relate to an adjustment mechanism with a constant force elastomeric spring for securing the head-mountable device to a user's head with constant force in a comfortable and secure manner. These adjustment mechanisms enable a user to place a head-mountable device on the user's head and over the user's eyes while adaptively adjusting the head-mountable device to accommodate the different head shapes and sizes of various users. The constant force adjustment mechanism allows a head-mountable device to maintain a constant, predictable, and comfortable amount of force on/around a user's head and face, creating a more immersive and comfortable AR/VR experience. In addition, the adjustment mechanisms described herein can accommodate functioning electronic components within securement straps, including electronic cables routed from the strap to the display portion of the device, even as the strap is adjusted in length and stretched during use.

Conventional head-mountable devices have limited adjustment mechanisms, if any, for adaptively adjusting to a user's face and head while maintaining a constant force and housing electronic components. This can limit the functionality of the strap and cause user discomfort and frustration by fitting too tight or too loose, interrupting a user's AR/VR experience to re-adjust the head-mountable device throughout use. Conventional head-mountable devices with adjustment mechanisms lend to bulky adjustment mechanisms with limited adjustment range and/or non-constant and unpredictable force applied to a user's head, preventing a user from having a fully engaging and immersive experience. Further, conventional head-mountable devices with conventional adjustment mechanisms can pinch, wrinkle, and even tear fabric as the adjustment mechanism expands and contracts.

In addition to having limited or no adjustment mechanisms, a conventional head-mountable device may also lack an effective cable management system. The lack of or ineffective management of cables leads to decreased reliability and increased repairs for head-mountable devices with conventional cable management systems. Similarly, head-mountable devices incorporating a cable management system does so in bulky, non-ergonomic ways that may not conceal the cable or effectively route the cable from moving parts that can pinch, twist, or damage the cable.

In contrast, the head-mountable devices of the present disclosure include a constant force adjustment mechanism and active cable management, creating an ergonomic, concealed and precise way for managing cables while maintaining a constant and comfortable amount of force on/around a user's face. This creates a more immersive and prolonged user experience allowing a user to comfortably don a head-mountable device without the need for additional adjustments throughout use of the head-mountable device.

In some examples, the wearable electronic device includes a first portion with a display, a securement strap, and an electrical cable. The securement strap can include a track, a pulley translatably secured along the track, and an elastic member secured to the securement strap on one end and secured to the pulley on another end. In at least one example, the electrical cable has a first end connected to the first portion and a second end connected to the securement strap, with the electrical cable being routed around and/or against pulley. In some examples, the cable is routed in a serpentine pattern.

In other examples, an adjustability mechanism connects a first portion, such as a display, and a second portion, such as a strap, of an electronic device. The adjustment mechanism includes a pulley in a track, an elastic member biasing the pulley one way, and a fixed length electrical cable biasing the pulley in another way. For example, the electrical cable may undergo tension forces in one direction equal to the elastic member biasing the pulley in another direction, thus keeping the electrical cable in a desired position throughout a range of motion of the adjustment mechanism and strap length.

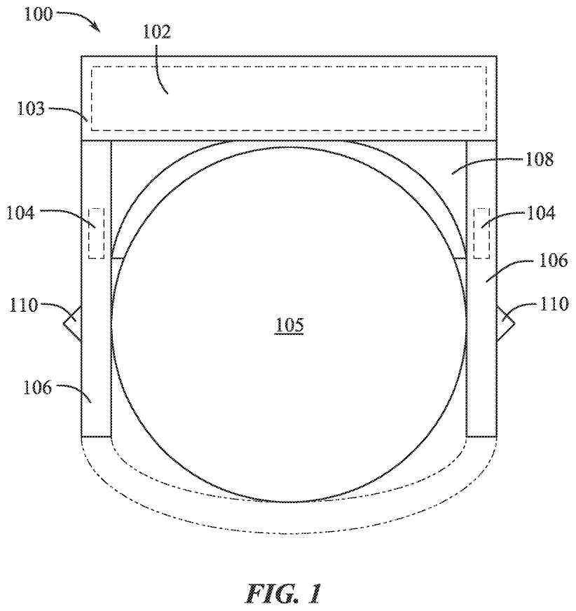

These and other embodiments are discussed below with reference to FIGS. 1-5. However, those skilled in the art will readily appreciate that the detailed description given herein with respect to these Figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a head-mountable device 100. As used herein, the terms “wearable electronic device” and “head-mountable device” refer to a device with a display that is placed over a user's eyes and donned by a user, providing an augmented reality and/or virtual reality experienced. The head-mountable device 100 can be substantially similar to, including some or all the features of, the head-mountable devices described herein, such as the head-mountable device 100. In some examples, the head-mountable device 100 can include a support, headband, retention band, or securement strap 106 connected to a first portion 103 which can include a display 102. The display 102 can include one or more optical lenses or display screens in front of the eyes of a user. The display 102 can include a display or display unit for presenting an augmented reality visualization, a virtual reality visualization, or other suitable visualization to a user. Additionally, the display 102 can be disposed in a first portion 103 of the head-mountable device 100. In another example the head mountable-device 100 includes the display 102 and a facial engagement feature 108 disposed on the first portion 103 of the head-mountable device 100.

The facial engagement feature 108 disposed on the first portion 103 of the head-mountable device 100 can be positioned between the display 102 and a user's face. The term “facial engagement feature” refers to a portion of the head-mountable device 100 that engages (i.e., contacts or conforms to) a user's face. In particular, the facial engagement feature 108 can include portions of a head-mountable device that conform or press against regions of a user's face. In some examples, the facial engagement feature 108 can include a pliant (or semi-pliant) facetrack or lumen that spans the forehead, wraps around the eyes, contacts other regions of the face (e.g., zygoma and maxilla regions), and bridges the nose.

The securement strap 106 is configured to secure the first portion 103 relative to a user's head 105 (e.g., such that the display 102 is maintained in front of a user's eyes). The securement strap 106 can be constructed from elastic material, inelastic material, or a combination of elastic and inelastic material. The securement strap 106 is adjustable such that the securement strap 106 conforms to the various shapes and sizes of a user's head 105. In some examples, the securement strap 106 secures the head-mountable device 100 via friction between the user's head 105 and the securement strap 106. In some examples, the securement strap 106 elastically secures the head-mountable device 100 to the user's head 105 via an adjustment mechanism 104 including a pulley and a track, an elastic member, and an electrical cable. In some examples, the securement strap 106 is disposed above or on an ear 110 of the user's head 105, supporting the head-mountable device 100.

In one example, the head-mountable device 100 includes the display portion 102 and the securement strap 106. The securement strap 106 can be connected to the display portion 102 via the adjustment mechanism 104. The adjustment mechanism 104 includes a pulley, a track, an elastic member, and an electrical cable. The display portion 102 can separate from the securement strap 106 by a certain distance corresponding to the user's head 105 and facial features.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

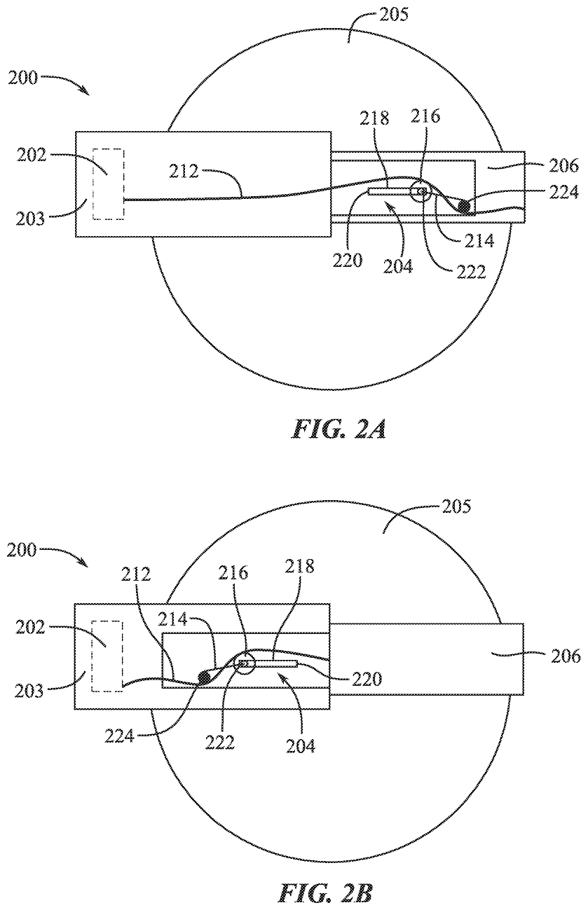

In one example, as shown in FIG. 2A, a head-mountable device (e.g. wearable electronic device) 200 includes securement strap 206, a first portion 203 and at least a display 202 disposed in the first portion 203 of the head-mountable device 200. The securement strap 206 can also include an adjustment mechanism 204, which includes a track 218, a pulley 216 translatably secured along the track 218, an elastic member 214, and an electrical cable 212.

In one example, the track 218 includes a first terminus 222 and a second terminus 220 wherein the pulley 216 movement is constrained. The pulley 216 can be constrained via elastic force exerted by the elastic member 214 at any location between the first terminus 222 and the second terminus 220. For example, the pulley 216 can be at rest and biased to the first terminus 222 via tension forces exerted by the elastic member 214 prior to a user's head 205 donning the head-mountable device 200. Each elastic member may exert forces of 1.5 N to 7.5 N per side to properly secure the head-mountable device 200 to the user's head 105 in a comfortable way. As the user 205 dons the head-mountable device 200, exerting a force and stretching the first portion 203 away from the securement strap 206 elongating the elastic member 214, the electrical cable 212 biases the pulley 216 translating the pulley 216 from a first position at the first terminus 220 to a second position between the first terminus 222 and the second terminus 220. The pulley 216 remains under a constant force exerted by the elastic member 214, securing the head-mountable device 200 to the user's head 205. While donning the head-mountable device 200 the first portion 203 of the head-mountable device 200 remains in tension via the electrical cable 212, the electrical cable 212 connecting the first portion 203 to the securement strap 206 exerting a tension force equal to the elastic force exerted by the elastic member 214.

In some examples, the elastic member 214 includes hyperelastic systems (e.g. green elastic materials) or materials with large elastic deformation limits, for example, silicones or different runners with different force profiles and elastic moduli, such as Etsu KET 1001-30/40/50/60A durometers. The combination of various materials provides the advantage of varying the elastic deformations limits to maintain a linear/constant force profile with respect to distance. In another example, the various materials are overmolded with other materials of lover durometer that allows for a linear/constant force profile. In some examples, a linear/constant force profile, with respect to distance, can be achieved in the elastic member 214 by removing portions of the elastic material (e.g. creating slits, holes, cuts, radii, etc.). The removed portions can be uniform in shape or can vary in shape, size, depth, and/or volume. Similarly, the removed portions and be an array that is uniform or non-uniform with respect to placement, spacing, orientation, etc.

In another example shown in FIG. 2A, the securement strap 206 includes an adjustment mechanism 204 disposed on the securement strap 206. The adjustment mechanism 206 includes the pulley 216, the track 218, the elastic member 214, and the electrical cable 214. The electrical cable 212 can connect the display 202 to the securement strap 206. In another example, the display 202 can be disposed in the first portion 203, the electrical cable 212 connecting the display 202 via the first portion 203. The adjustment mechanism 206 can further include a protrusion 224 wherein the electrical cable 212 can be routed around/against the protrusion 224.

FIG. 2B shows the head-mountable device 200 including the first portion 203 and the securement strap 206. The first portion 203 includes the display 202, the track 218 including the first terminus 222 and the second terminus 220, the pulley 216, the elastic member 214, and the electrical cable 212. As previously discussed, the pulley 216 can be biased to the first terminus 222 via elastic force exerted on the pulley 216 via the elastic member 214. In this way, the pulley 216 remains at the first terminus 222 until the head-mountable device 200 undergoes a force, pulling the first portion 203 away from the securement strap 206. The force pulling the first portion 203 away from the securement strap 206 (e.g. a user stretching the head-mountable device 200 over the user's head 205, placing the first portion 203 over the user's eyes and the securement strap 206 on the user's head 205) exerts an opposite but equal force on the electrical cable 212, biasing the pulley 216 toward the second terminus 220.

In another example shown in FIG. 2B, the first portion 203 of the head-mountable device 200 includes the adjustment mechanism 206 disposed on the first portion 203. The adjustment mechanism 206 includes the pulley 216, the track 218, the elastic member 214, and the electrical cable 214. The electrical cable 212 can connect the first portion 203 to the securement strap 206. In another example, the display 202 can be disposed in the first portion 203, the electrical cable 212 connecting the display 202 via the first portion 203. The adjustment mechanism 206 can further include a protrusion 224 wherein the electrical cable 212 can be routed around/against the protrusion 224.

Any of the features, components, and/or parts, including the arrangements and configurations thereof shown in FIGS. 2A-2B can be included, either alone or in any combination, in any of the other examples of devices, features, components, and parts shown in the other figures described herein Likewise, any of the features, components, and/or parts, including the arrangements and configurations thereof shown and described with reference to the other figures can be included, either alone or in any combination, in the example of the devices, features, components, and parts shown in FIGS. 2A-2B.

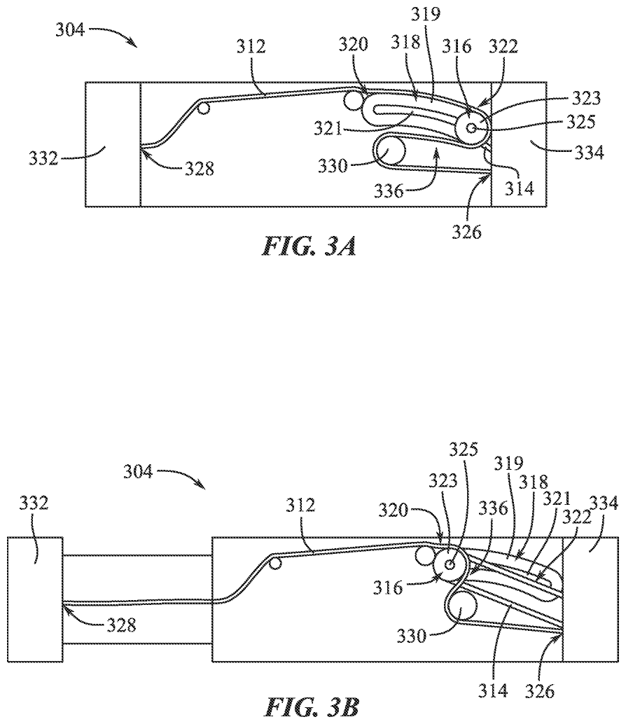

FIGS. 3A-3B illustrates an adjustment mechanism 304 in a first state and a second state, respectively. The adjustment mechanism 304 can connect a first portion 332 of an electronic device with a second portion 334 of an electronic device. The electronic device can include a head-mountable display device with the first portion 332 and the second portion 334 including a securement strap. Alternatively, the first portion 332 can include a securement strap and the second portion 334 can include a display portion of a head-mountable device. In at least one example, the adjustment mechanism 304 can be a part of the first portion 332 such that the first portion 332 includes the adjustment mechanism 304. In at least one example, the adjustment mechanism 304 can be a part of the second portion 334 such that the second portion 334 includes the adjustment mechanism 304. In at least one example, the adjustment mechanism 304 can be independent of both the first portion 332 and the second portion 334.

The adjustment mechanism 304 further includes an electrical cable 312 routed around/against a protrusion 330. The electrical cable 312 includes a first end 328 connected to the first portion 332 which connects to the first portion of a head-mountable device, such as the head-mountable device 100 shown in FIG. 1. The electrical cable 312 further includes a second end 326 which can connects to a securement strap, such as the securement strap 106 shown on the head-mountable device 100 shown in FIG. 1. In some examples, the electrical cable 312 can be a fixed length. In other examples, the electrical cable 312 can be a variable length. In at least one example, the electrical cable 312 can be routed around a pulley 316 and the protrusion 330 forming a serpentine configuration 336 between the first end 328 and the second end 326 of the electrical cable 312. In at least one example, the protrusion 330 can extend parallel to an axle 325 of the pulley 316.

The serpentine configuration 336 can vary in curvature as the pulley 316 is translated from a first terminus 322 toward a second terminus 320 being translated by changes from the first state, shown in FIG. 3A, to the second state, shown in FIG. 3B. In at least one example, the adjustment mechanism 304 includes a track 318 including a body 319 defining a translation path 321. In at least one example, the translation path 321 can be curved. In other examples, the translation path 321 can take any shape or route to guide the pulley 316 as shown in FIGS. 3A and 3B. In at least one example, the curvature of the translation path 321 can be designed to accommodate or compliment the curvature of a user's head on which the device is worn. The adjustment mechanisms described herein can route and manage certain components, including biasing members 314 and electrical cables 312, in such a way that those components can be arranged within a thin profile of the securement strap or display portion of the device without negatively interfering with each other or reducing the functionality of the components and adjustment mechanisms.

In at least one example, a biasing member 314 engages the pulley 316 to urge or bias the pulley in a first direction (e.g., toward the first terminus 322) along the translation path 321 defined by the track 318. The biasing member 314 can include any component configured to act on the pulley 316, including elastic bands, coil springs, constant force springs, and so forth. The biasing member 314 can engage with pulley 316 and another anchor point somewhere on the adjustment mechanism or the first or second portions 332, 334 to urge the pulley 326 in a first direction along the translation path 321. In the example shown in FIGS. 3A and 3B, the biasing member 314 is an elastic band, for example a rubber band. Thus, the biasing member 314 can also be referred to as an elastic member 314.

In at least one example, the pulley 316 can include a wheel 323 rotatable around an axle 325 and the biasing member 314 is configured to urge the axle 325 in a first direction along the translation path 321 of the body 319 of the track 318. In at least one example, the electrical cable 312 is routed at least partially around the wheel 323 of the pulley 316 with the first end of the electrical cable 312 secured to the first portion 332 and the second end of the electrical cable 312 secured to the second portion 334. In at least one example, the biasing member 314 is variable in length as it stretches and contracts and the electrical cable 312 is fixed in length. As the user separates the first portion 332 from the second portion 334, as shown in FIG. 3B, the pulley 316 moves in reaction to a force thereon provided by the electrical cable 312 biasing the pulley 316 toward the second terminus 320 of the track 318, and the biasing member 314 acting on the pulley 316 keeps the fixed-length electrical cable 312 in tension.

For example, the first state shown in FIG. 3A is the normal state with the pulley 316 located in the first terminus 322 and constrained by an elastic member 314 exerting elastic force, biasing the pulley 316 toward the first terminus 322. The second state in FIG. 3B shows the adjustment mechanism 304 in an extended state, the pulley 316 being translated to the second terminus 320 from the first terminus 322. The electrical cable 312 acts on the pulley 316 creating a tension force, for example a user separating the first portion 332 from the second portion 334 (i.e., increasing a distance there between) greater than the elastic force of the elastic member 314, causing the first portion 332 to extend from the first state.

In some examples, the adjustment mechanism 304 is ergonomically curved to conform to the side of a user's head in a comfortable and stylish way. The track 318, the elastic member 314, pulley 316, and electrical cable 312 conform to the curvature and maintain a low profile perpendicular to a user's head. This allows the adjustment mechanism 304 to have a smaller side profile than other more bulky and esthetically displeasing adjustment mechanisms. For example, an adjustment mechanism with a conventional spring may be loud and bulky or even get stuck in the head-mountable device's fabrics as the adjustment mechanism expands and contracts. For these reasons, an elastic member, such as the elastic member disclosed in this application is advantageous.

Any of the features, components, and/or parts, including the arrangements and configurations thereof shown in FIG. 3A-3B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 3A-3B.

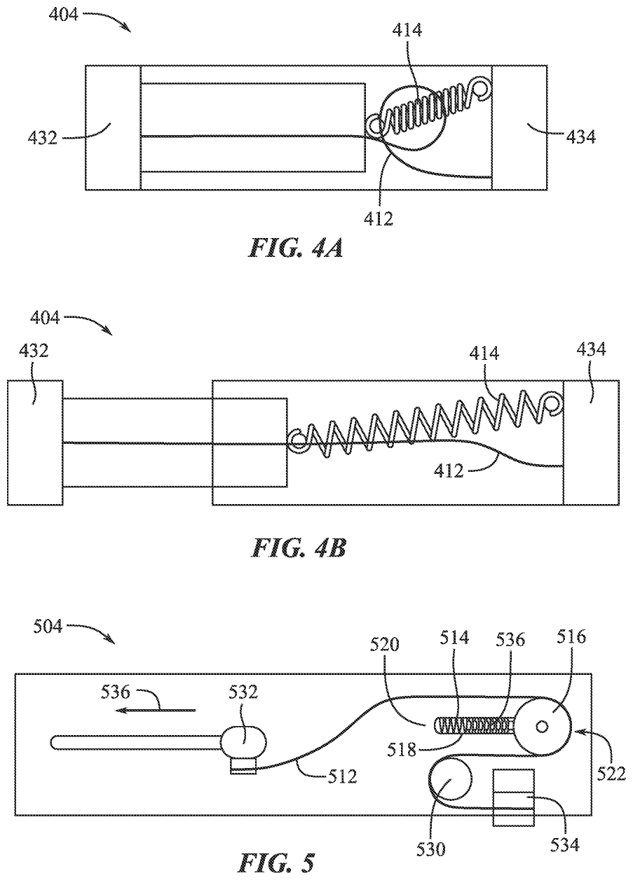

FIGS. 4A-4B illustrates another example of an adjustment mechanism 404 in a first state and second state, respectively. The adjustment mechanism 404 can connect a first portion 432 and a second portion 434 of an electronic device, for example a head-mountable device. In at least one example, the first portion 432 can include the display 102 shown in FIG. 1. In at least one example, the second portion 434 can include the securement strap 106 of the head-mountable device 100 shown in FIG. 1. However, in one or more other examples, the first portion 432 can include a securement strap and the second portion 434 can include a display portion.

In one example, the adjustment mechanism 404 includes an electrical cable 412 with passive cable management, whereas FIGS. 3A-3B show an electrical cable 312 with active cable management. The term “active cable management” can refer to management of an electrical or optical cable in a routed, organized, and/or supported way, such as a cable in tension that is extended and retraced in the same way each time. For example, the electrical cable 312 of FIGS. 3A-3B restrain the electrical cable 312 is such a way that the electrical cable 312 is always in tension. This tension on the electrical cable 312 enables an organized extension and retraction of an electrical cable. The term “passive cable management” refers to management of an electrical or optical cable in a non-supported way, such as a cable not in tension that does not extend and retract in the same way each time, such as the electrical cable 412 illustrated in FIGS. 4A-4B.

FIGS. 4A and 4B show a nominal (e.g., a first state) and extended (e.g., a second state) configuration of the adjustability mechanism 404, respectively. A biasing member 414 linearly increases in elastic force as the adjustment mechanism 404 is extended from the first state, FIG. 4A to the second state, FIG. 4B. In this example, the electrical cable 412 is passively managed and disposed within the adjustability mechanism 404. For example, in a nominal state, the electrical cable 412 can coil, bend, or otherwise be manipulated to conform to the interior volume of the adjustability mechanism 404. In another example, the electrical cable is disposed on partially or completely on the outside of the adjustability mechanism 404. In this way, the adjustability mechanism 404 can secure a head-mountable device, such as the head-mountable device 100 shown in FIG. 1 to the head of a user, allowing

Any of the features, components, and/or parts, including the arrangements and configurations thereof shown in FIG. 4A-4B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 4A-4B.

FIG. 5 illustrates an adjustability mechanism 504 that compresses a biasing member 514, connecting a first portion 532 and a second portion 534 of an electronic device, such as the head-mountable device 100 shown in FIG. 1. The adjustability mechanism 504 includes a pulley 516 in a track 518, a biasing member 514 biasing the pulley 516 one way, for example FIG. 5 shows the biasing member 514 applying a compressive load to the pulley 516 such that the pulley 516 is biased toward a first terminus 522. As the second portion 532 is extended in the direction of arrow 536, the second portion 534 remains fixed. The extension of the second portion 532 in the direction of arrow 536 causes the pulley to translate along an axis normal to the circumference of the pulley 516, compressing the biasing member 514, moving toward the second terminus 520.

In some examples, the pulley can include a hard stop 536 that is adjustable to restrict the compressive distance of the pulley 516 toward the second terminus 520. For example, a user may wish to tune the adjustability mechanism 504 such that the hard stop 536 is reached prior to reaching the second terminus 520. This can be done to accommodate a certain user's head diameter or shape.

As discussed previously, the adjustability mechanism 504 includes an electrical cable 512 of a fixed length and positioned between the first portion 532 and the second portion 534. In some examples, the electrical cable 512 is in a serpentine shape and actively managed such that the cable 512 extends and retracts in the same way for each actuation.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

In some examples, personal information data can be used by the present exemplary systems and methods to enhance or personalize the user experience. In such examples, the collection, storage, use, and/or transmission of any personal information data should be conducted according to well recognized and accepted protocols and procedures directed at avoiding any improper, unauthorized, or inadvertent access thereof. However, the present exemplary systems and methods can be performed without access to such personal information data.

The foregoing description used specific nomenclature to provide an in-depth understanding of the described examples. However, the specific details are not required in order to practice the described embodiments and the foregoing descriptions of the specific embodiments described herein are presented for purposes of illustration and description. They are not intended to be exhaustive or to limit the embodiments to the precise forms disclosed. Rather, many modifications and variations are possible in view of the above teachings.

What is claimed is:

1. A wearable electronic device, comprising:
a first portion;
a securement strap comprising:
a track having a first terminus and a second terminus;
a pulley translatably secured to the track; and
a biasing member having a first end secured to the securement strap and a second end secured to the pulley; and
an electrical cable having a first end connected to the first portion and a second end connected to the securement strap, the electrical cable routed at least partially around the pulley.

2. The wearable electronic device of claim 1, wherein the biasing member biases the pulley toward the first terminus.

3. The wearable electronic device of claim 2, wherein when a force pulls the securement strap away from the first portion, the electrical cable biases the pulley toward the second terminus.

4. The wearable electronic device of claim 1, wherein:
the pulley rotates about an axle;
the securement strap further comprises a protrusion extending parallel to the axle; and
the electrical cable is routed around the protrusion.

5. The wearable electronic device of claim 4, wherein the cable is routed around the pulley and the protrusion in a serpentine manner.

6. The wearable electronic device of claim 1, wherein the electrical cable is fixed in length.

7. The wearable electronic device of claim 1, wherein the first portion includes a display.

8. The wearable electronic device of claim 1, wherein the biasing member maintains the electrical cable in tension as the first portion is pulled away from the securement strap.

9. A head-mountable display, comprising:
a display portion;
a securement strap; and
an adjustment mechanism connecting the securement strap to the display portion, the adjustment mechanism comprising:
a pulley;
a elastic member urging the pulley in a first direction; and
an electrical cable routed at least partially around the pulley to bias the pulley in a second direction.

10. The head-mountable display of claim 9, wherein the electrical cable extends from the display portion to the securement strap.

11. The head-mountable display of claim 9, wherein the securement strap comprises the adjustment mechanism.

12. The head-mountable display of claim 9, wherein the display portion comprises the adjustment mechanism.

13. The head-mountable display of claim 9, wherein:
the pulley includes a wheel rotatable around an axle; and
the elastic member includes an elastic band configured to urge the axle in the first direction.

14. The head-mountable display of claim 13 the adjustment mechanism further including a track configured to guide the axle in the first direction and the second direction.

15. The head-mountable display of claim 14, wherein:
the track defines a translation path; and
the pulley is coupled to the track such that the pulley is configured to move along the translation path.

16. An adjustability mechanism connecting a first portion and a second portion of an electronic device, the adjustability mechanism comprising:
a track defining a translation path;
a pulley coupled to the track;
an elastic band configured to bias the pulley in a first direction along the translation path; and
a fixed length electrical cable extending from the first portion to the second portion and configured to bias the pulley in a second direction along the translation path.

17. The adjustability mechanism of claim 16, wherein the translation path is curved.

18. The adjustability mechanism of claim 16, wherein the electronic device includes a head-mountable display.

19. The adjustability mechanism of claim 18, wherein the first portion comprises a display and the second portion comprises a securement strap.

20. The adjustability mechanism of claim 19, wherein the elastic band comprises a first end connected to the pulley and a second end connected to the securement strap.
